(19) United States
(12) Patent Application Publication
(10) Pub. No.: US 2013/0333447 A1
(43) Pub. Date: Dec. 19, 2013

(54) LEAKAGE DETECTION

(71) Applicants: Thomas Arthur White, Canoga Park, CA (US); Seyed Massoud Azizi, Canoga Park, CA (US)

(72) Inventors: Thomas Arthur White, Canoga Park, CA (US); Seyed Massoud Azizi, Canoga Park, CA (US)

(21) Appl. No.: 13/524,088

(22) Filed: Jun. 15, 2012

(51) Int. Cl. G01M 3/28

(52) U.S. Cl. 73/40.5 R

(57) ABSTRACT

A leak detector includes a fabric having a conductor. The fabric has an electric property between the conductor and a reference. The electric property has a first value in response to the fabric being in a non-wetted state with regard to a working fluid and the electrical property has a second value different than the first value in response to the fabric being in a wetted state with regard to the working fluid.

### BACKGROUND

This disclosure relates to improvements in leakage detection.

General usage leak detectors are known and used to detect leakage of relatively low temperature fluids in a system, such as water. A typical leak detection system utilizes an electric capacitor on the exterior of a pipe within the system. Water that leaks from the pipe contacts the capacitor, changing the capacitance and indicating a leak.

### SUMMARY

A leak detector according to an exemplary aspect of the present disclosure includes a fabric including a conductor, the fabric having an electric property between the conductor and a reference, the electric property having a first value in response to the fabric being in a non-wetted state with regard to a working fluid and the electrical property having a second value different than the first value in response to the fabric being in a wetted state with regard to the working fluid.

In a further non-limiting embodiment of the foregoing example, the working fluid is a high temperature working fluid.

In a further non-limiting embodiment of any of the foregoing examples, the fabric is selected based on the high temperature working fluid.

In a further non-limiting embodiment of any of the foregoing examples, the working fluid is molten salt.

In a further non-limiting embodiment of any of the foregoing examples, the fabric is adjacent a conduit.

In a further non-limiting embodiment of any of the foregoing examples, the conduit contains the working fluid.

In a further non-limiting embodiment of any of the foregoing examples, the reference is a second conductor of the fabric.

In a further non-limiting embodiment of any of the foregoing examples, the reference is ground.

In a further non-limiting embodiment of any of the foregoing examples, the reference is a conduit.

A leak detection system according to an exemplary aspect of the present disclosure includes a conduit for carrying a working fluid, and a detector on the outside of the conduit, the detector including a fabric with a conductor having an electrical property that changes responsive to contact with the working fluid.

In a further non-limiting embodiment of the foregoing example, the fabric is a sleeve configured to fit on the outside of the conduit, the sleeve extending around a central axis and between axial ends and an inner surface and an outer surface relative to the central axis. The conductor has a portion that is embedded within the fabric between the inner surface and the outer surface.

In a further non-limiting embodiment of any of the foregoing examples, the sleeve includes at least one groove on at least one of the outer surface or the inner surface.

In a further non-limiting embodiment of any of the foregoing examples, the at least one groove is elongated and extends along a longitudinal axis that is perpendicular to a longitudinal axis defined by the sleeve.

A leak detector according to an exemplary aspect of the present disclosure includes a porous sleeve configured to fit on the outside of a conduit, the porous sleeve extending around a central axis and between axial ends and an inner surface and an outer surface relative to the central axis, and an electrical circuit having at least a portion that is carried by the porous sleeve, the electrical circuit having an electrical property that changes responsive to contact with a leaked fluid.

In a further non-limiting embodiment of the foregoing example, the electrical circuit includes a controller configured to activate an indicator in response to change in the electrical property.

In a further non-limiting embodiment of any of the foregoing examples, the porous sleeve is a fabric.

In a further non-limiting embodiment of any of the foregoing examples, the electrical circuit includes a portion that is dissolvable in the leaked fluid.

In a further non-limiting embodiment of any of the foregoing examples, the electrical circuit is open when free of any contact with the leaked fluid.

In a further non-limiting embodiment of any of the foregoing examples, the electrical circuit is closed when free of any contact with the leaked fluid.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 shows an example leak detection system.

FIG. 2 shows a modified leak detection system having an electrical circuit that is normally closed.

FIG. 3 shows a cross-section through a conduit and portion of a leak detector.

FIG. 4 shows an example of a sleeve of a leak detector having a groove on an outer surface.

FIG. 5 shows another example sleeve of a leak detector having a groove on an inner surface.

FIG. 6 shows another example of a sleeve of a leak detector having multiple grooves that run parallel to electrical leads.

FIG. 7 shows an example of a porous sleeve of a leak detector.

FIG. 8 shows another example of a leak detector in which a conduit serves an electrical lead.

### DETAILED DESCRIPTION

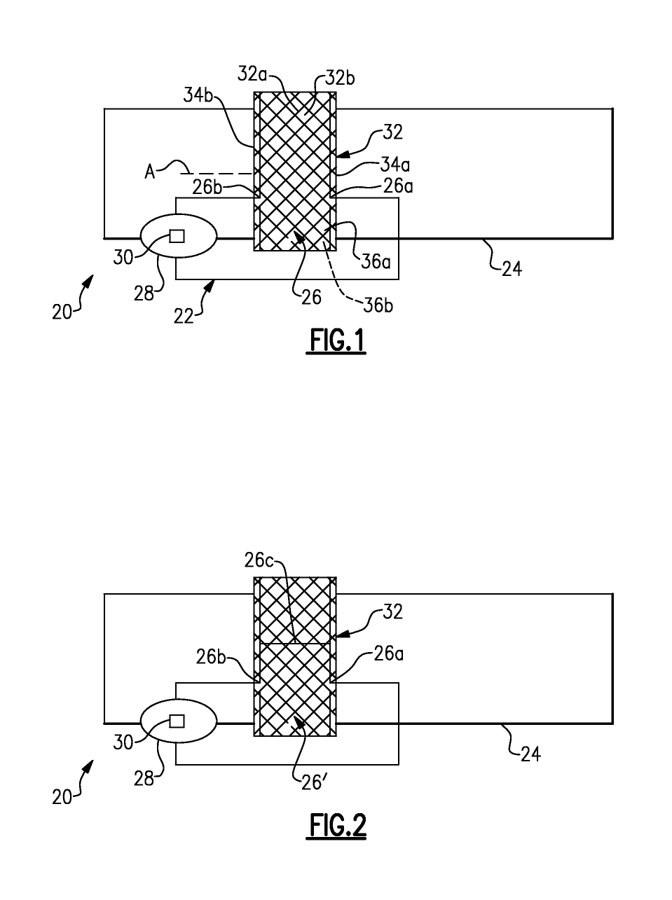

FIG. 1 illustrates an example leak detection system 20 including a leak detector 22. In this example, the leak detection system 20 is adapted for a system that carries a relatively high temperature fluid, such as molten salt in a concentrated solar power plant. It is to be understood, however, that some or all of the embodiments disclosed herein can be also used in other systems or systems that utilize lower or higher temperature fluids. Other examples are the use of the leak detection system 20 for in-situ medical devices to detect leaking body fluids after surgery.

In the illustrated example, the leak detection system 20 includes a conduit 24 that carries a working fluid. The working fluid can be a molten salt, such as potassium nitrite salt, sodium nitrite salt, fluoride salt or a mixture of salts. The leak detector 22 is mounted on the outside of the conduit 24 and has an electrical property that changes in response to contact with the working fluid. Thus, the change in the electrical property indicates a leak of the working fluid from the conduit 24. In this regard, the leak detector 22 can be located on a portion of the conduit 24 where leaked working fluid is likely to flow to. For instance, the leak detector 22 can be located at a vertically low portion on the conduit 24 such that any leaked working fluid gravitationally flows downward and over the leak detector 22.

In the illustrated example, the leak detector 22 includes an electrical circuit 26 that has a conductor, first electrical lead 26a, and a reference conductor, second electrical lead 26b. The electrical leads 26a/26b are connected to a controller 28. For example, the controller 28 can include an indicator 30, such as a visual indicator, audible indicator, etc., control logic, a power source or other additional features for controlling the operation of the leak detector 22.

The electrical leads 26a/26b are carried on a fabric 32 that is configured in this example as a sleeve to fit on the outside of the conduit 24. As an example, the fabric 32 includes fibers 32a that are arranged in a fiber network and pores 32b extending between the fibers 32b. The fibers 32a can be natural, organic fibers, synthetic polymer fibers or other fibers suitable for the intended use. That is, the fabric 32 is selected based on the type and temperature of the working fluid. The fiber network is a woven structure, for example. The fabric 32 sleeve has an inner diameter corresponding to the diameter of the conduit 24 to enable the fabric 32 to be slid over the conduit 24.

In this example, the fabric 32 sleeve is cylindrical and extends around a central axis A between axial ends 34a/34b and an outer surface 36a and an inner surface 36b. As can be appreciated, the electrical leads 26a/26b can be attached on the outer surface 36a of the fabric 32, attached on the inner surface 36b of the fabric 32 or embedded within the fabric 32 between the outer surface 36a and the inner surface 36b.

In this example, the electrical circuit 26 is open when free of any contact with the working fluid. Leaked working fluid from the conduit 24 flows into the fabric 32 and bridges the electrical leads 26a/26b to complete the circuit. In the completed circuit, electrical current can flow between the electrical leads 26a/26b and change the state of an electrical property of the leaked detector 22, to indicate a leak.

Alternatively, as shown in FIG. 2, a modified electrical circuit 26′ is closed when free of any contact with the working fluid. In this example, the electrical circuit 26′ includes a portion 26c that changes electrical properties when in contact with the working fluid. Thus, when there is no leak, current flows between the electrical leads 26a/26b through the portion 26c. However, upon leakage of the working fluid from the conduit 24, the leaked working fluid dissolves or changes the electrical properties of the portion 26c to change the state of the electrical circuit 26′. The change from one state to the other state indicates a leak.

FIG. 3 illustrates a cross-section showing a further example in which there is a layer of thermal insulation 40 between the conduit 24 and the leak detector 22. In this example, the fabric 32 is mounted on the outside of the layer of thermal insulation 40. Specifically, in systems such as concentrated solar power plants that carry working fluid at temperatures typically in excess of 500° F./260° C., the conduit 24 includes the layer of thermal insulation 40 to reduce thermal losses.

FIG. 4 illustrates another example fabric 132 that can be used in the leak detector 22. In this disclosure, like reference numerals designate like elements where appropriate and reference numerals with the addition of one-hundred or multiples thereof designate modified elements that are understood to incorporate the same features and benefits of the corresponding elements. In this example, the fabric 132 includes at least one groove 150 on the outer surface 36a thereof. The groove 150 is generally larger than the pores between the fabric fibers. The groove 150 facilitates directing any leaked working fluid into contact with the electrical leads 26a/26b. For example, any leaked working fluid flowing over the sleeve 132 is caught within the groove 150 and thereby directed into contact with the electrical leads 26a/26b. The groove 150 thus enhances leak detection where the fluid or molten salt might not otherwise contact the leads 26a/26b.

FIG. 5 shows another example sleeve 232 having a groove 250 on the inner surface 36b thereof. The groove 250 operates similar to the groove 150 described above.

FIG. 6 illustrates a further example of a fabric 332 that includes multiple grooves 350 on the outer surface 36a. It is to be understood, however, that the grooves 350 may alternatively may be on the inner surface 36b. Although only two grooves 350 are shown, additional grooves may be used. In this example, the grooves 350 are elongated in a direction that is generally parallel to the central axis A of the fabric 332 sleeve. The electrical leads 26a/26b generally extend in a direction parallel to axis A′, which is perpendicular to the central axis A. Orienting the grooves 350 to be perpendicular to the electrical leads 26a/26b facilitates directing any of the leaked working fluid into contact with the electrical leads 26a/26b.

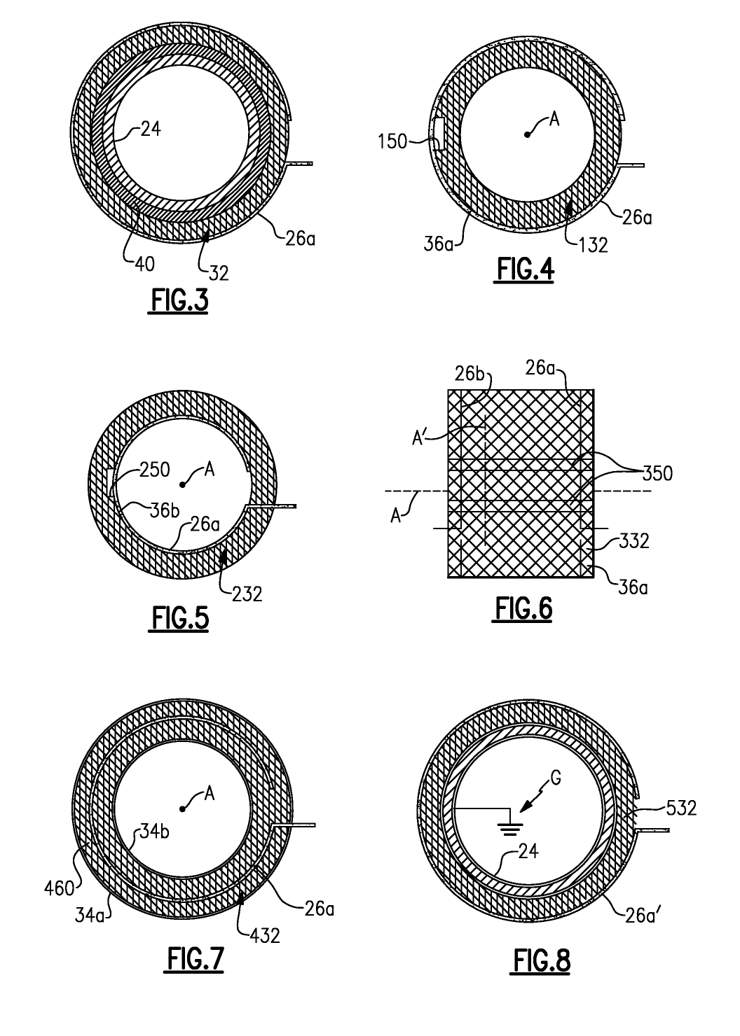

FIG. 7 illustrates another example fabric 432, or porous sleeve in this example, that can be used in the leak detector 22. In this example, the electrical leads 26a/26b (only electrical lead 26a shown) are embedded within the fabric 432 between the inner surface 34b and the outer surface 34a. The fabric 432 includes pores 460 through which any leaked working fluid can flow to contact and bridge the electrical leads 26a/26b. The size of the pores 460 in the fabric 432 can be tailored to the viscosity of the working fluid, to provide a wicking action that facilitates leakage detection. Further, the fabric 432 protects the electrical leads 26a/26b from outside damage.

FIG. 8 illustrates another example in which the conduit 24 serves as an electrical lead in place of the electrical lead 26b. The conduit 24 is grounded at G such that any leaked working fluid from the conduit 24 bridges the fabric 532 to complete the circuit between the electrical lead 26a′ and the conduit 24, which thus serves as the reference.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A leak detector comprising:
a fabric including a conductor, the fabric having an electric property between the conductor and a reference, the electric property having a first value in response to the fabric being in a non-wetted state with regard to a working fluid and the electrical property having a second value different than the first value in response to the fabric being in a wetted state with regard to the working fluid.

2. The leak detector as recited in claim 1, wherein the working fluid is a high temperature working fluid.

3. The leak detector as recited in claim 2, wherein the fabric is selected based on the high temperature working fluid.

4. The leak detector as recited in claim 3, wherein the working fluid is molten salt.

5. The leak detector as recited in claim 1, wherein the fabric is adjacent a conduit.

6. The leak detector as recited in claim 5, wherein the conduit contains the working fluid.

7. The leak detector as recited in claim 1, wherein the reference is a second conductor of the fabric.

8. The leak detector as recited in claim 7 wherein the reference is ground.

9. The leak detector as recited in claim 7, wherein the reference is a conduit.

10. A leak detection system comprising:
a conduit for carrying a working fluid; and
a detector on the outside of the conduit, the detector including a fabric with a conductor having an electrical property that changes responsive to contact with the working fluid.

11. The system as recited in claim 10, wherein the fabric is a sleeve configured to fit on the outside of the conduit, the sleeve extending around a central axis and between axial ends and an inner surface and an outer surface relative to the central axis, and the conductor has a portion that is embedded within the fabric between the inner surface and the outer surface.

12. The system as recited in claim 11, wherein the sleeve includes at least one groove on at least one of the outer surface or the inner surface.

13. The system as recited in claim 13, wherein the at least one groove is elongated and extends along a longitudinal axis that is perpendicular to a longitudinal axis defined by the sleeve.

14. A leak detector comprising:
a porous sleeve configured to fit on the outside of a conduit, the porous sleeve extending around a central axis and between axial ends and an inner surface and an outer surface relative to the central axis; and
an electrical circuit having at least a portion that is carried by the porous sleeve, the electrical circuit having an electrical property that changes responsive to contact with a leaked fluid.

15. The leak detector as recited in claim 14, wherein the electrical circuit includes a controller configured to activate an indicator in response to change in the electrical property.

16. The leak detector as recited in claim 14, wherein the porous sleeve is a fabric.

17. The leak detector as recited in claim 14, wherein the electrical circuit includes a portion that is dissolvable in the leaked fluid.

18. The leak detector as recited in claim 14, wherein the electrical circuit is open when free of any contact with the leaked fluid.

19. The leak detector as recited in claim 14, wherein the electrical circuit is closed when free of any contact with the leaked fluid.
